(19) United States
(12) Patent Application Publication
(10) Pub. No.: US 2022/0020061 A1
(43) Pub. Date: Jan. 20, 2022

(54) APPARATUSES AND METHODS FOR POPULATING INVENTORY ASSOCIATED WITH CONTENT ITEMS IN ACCORDANCE WITH EMOTIONALLY GUIDED PLACEMENTS AND ADAPTATIONS

(71) Applicant: AT&T Intellectual Property I, L.P., Atlanta, GA (US)

(72) Inventors: Eric Zavesky, Austin, TX (US); Samuel Seljan, Portland, OR (US); Ashutosh Sanzgiri, Portland, OR (US); David Crawford Gibbon, Lincroft, NJ (US); Lee Begeja, Gillette, NJ (US)

(73) Assignee: AT&T Intellectual Property I, L.P., Atlanta, GA (US)

(21) Appl. No.: 16/928,625

(22) Filed: Jul. 14, 2020

(51) Int. Cl. G06Q 30/02; H04L 29/08; G06N 5/04; G06N 20/00

(52) U.S. Cl. CPC G06Q 30/0269; H04L 67/306; H04L 67/18; G06Q 30/0267; G06Q 50/01; G06Q 30/0275; G06N 5/04; G06N 20/00; H04L 67/10; G06Q 30/0261

(57) ABSTRACT

Aspects of the subject disclosure may include, for example, obtaining first data associated with a first presentation of a first portion of a first video, obtaining second data, wherein the second data is obtained: from a creator of the first video, by performing an analysis on the first portion of the first video, or a combination thereof, identifying an emotional trajectory of a first user during the first presentation in accordance with the first data and the second data, selecting a first creative in accordance with the emotional trajectory, and transmitting the first creative to a first communication device. Other embodiments are disclosed.

### FIELD OF THE DISCLOSURE

The subject disclosure relates to apparatuses and methods for populating inventory associated with content items in accordance with emotionally guided placements and adaptations.

### BACKGROUND

As the world is increasingly being connected via vast communication networks and communication devices, additional opportunities are being generated to distribute/disseminate content to users. The cost of creating and distributing/disseminating a content item is defrayed/reduced via the use of advertisements. For example, a content creator or a content distributor may allocate inventory associated with a content item, and an advertiser can pay a fee to have an advertisement of the advertiser populate the inventory. In turn, the content creator and/or the content distributor is compensated based on the fee.

Bidding models/technologies are frequently utilized as part of selecting advertisements from advertisers for populating inventory. However, from the perspective of an advertiser, it is not immediately clear what the impact will be of having an advertisement of the advertiser populate given inventory associated with a given content item. Similarly, from the perspective of a content creator/distributor, it is not clear how to increase (e.g., maximize) a return on investment from inventory given the pool of advertisements that may be available. This lack of information may lead to suboptimal resource (e.g., inventory and budget) allocations from the perspective of content creators/distributors and advertisers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of a system in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for targeting content items and/or creatives to users in accordance with emotional states. Other embodiments are described in the subject disclosure.

One or more aspects of the subject disclosure include providing a first portion of a first content item to a first client device associated with a first user, obtaining first data associated with a presentation of the first portion of the first content item by the first client device, obtaining second data associated with a first profile, identifying an emotional trajectory of the first user during the presentation of the first portion of the first content item in accordance with the first data and the second data, selecting a first advertisement in accordance with the emotional trajectory of the first user, and providing the first advertisement to the first client device.

One or more aspects of the subject disclosure include obtaining first data associated with a first presentation of a first portion of a first video, obtaining second data, wherein the second data is obtained: from a creator of the first video, by performing an analysis on the first portion of the first video, or a combination thereof, identifying an emotional trajectory of a first user during the first presentation in accordance with the first data and the second data, selecting a first creative in accordance with the emotional trajectory, and transmitting the first creative to a first communication device.

One or more aspects of the subject disclosure include presenting a first portion of a first content item during a first presentation, providing first data that indicates a first emotion of a first user during the first presentation, presenting, subsequent to the first presentation, a second portion of the first content item, a third portion of a second content item that is different from the first content item, or a combination thereof, during a second presentation, providing second data that indicates a second emotion of the first user during the second presentation, wherein the second emotion is different from the first emotion, and obtaining, in response to the providing of the first data and the providing of the second data, a first advertisement that is based on an emotional trajectory of the first user from the first emotion to the second emotion.

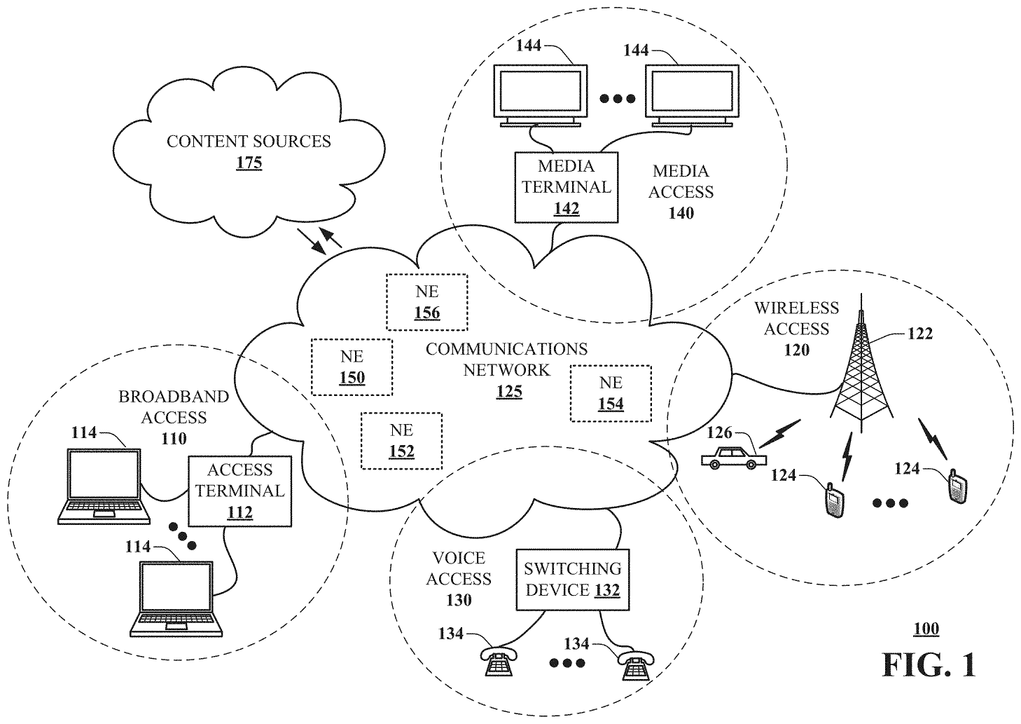

Referring now to FIG. 1, a block diagram is shown illustrating an example, non-limiting embodiment of a system 100 in accordance with various aspects described herein. For example, system 100 can facilitate in whole or in part providing a first portion of a first content item to a first client device associated with a first user, obtaining first data associated with a presentation of the first portion of the first content item by the first client device, obtaining second data associated with a first profile, identifying an emotional trajectory of the first user during the presentation of the first portion of the first content item in accordance with the first data and the second data, selecting a first advertisement in accordance with the emotional trajectory of the first user, and providing the first advertisement to the first client device. System 100 can facilitate in whole or in part obtaining first data associated with a first presentation of a first portion of a first video, obtaining second data from a creator of the first video, identifying an emotional trajectory of a first user during the first presentation in accordance with the first data and the second data, selecting a first creative in accordance with the emotional trajectory, and transmitting the first creative to a first communication device. System 100 can facilitate in whole or in part presenting a first portion of a first content item during a first presentation, providing first data that indicates a first emotion of a first user during the first presentation, presenting, subsequent to the first presentation, a second portion of the first content item, a third portion of a second content item that is different from the first content item, or a combination thereof, during a second presentation, providing second data that indicates a second emotion of the first user during the second presentation, wherein the second emotion is different from the first emotion, and obtaining, in response to the providing of the first data and the providing of the second data, a first advertisement that is based on an emotional trajectory of the first user from the first emotion to the second emotion.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

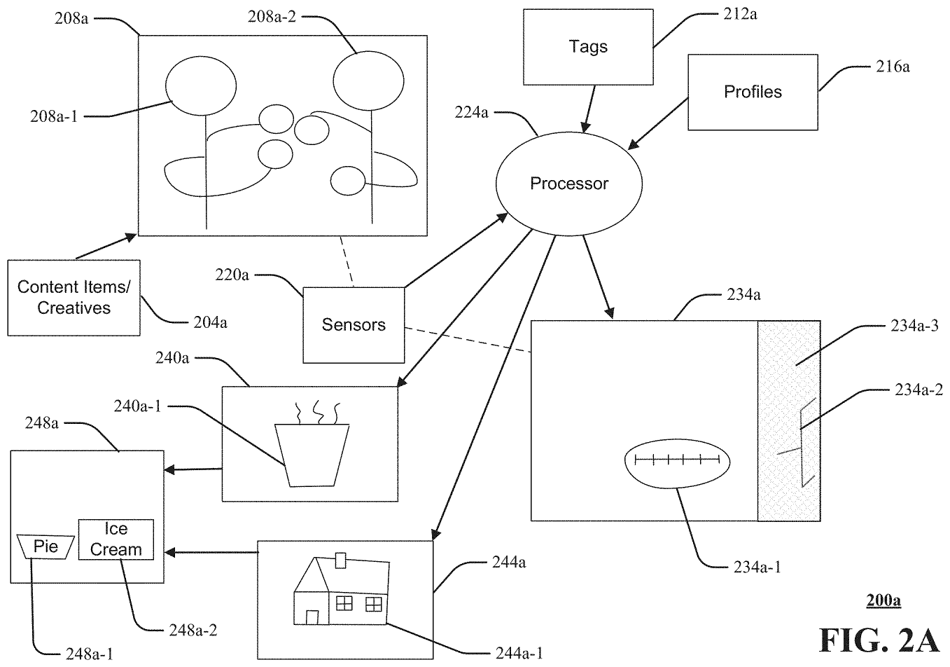

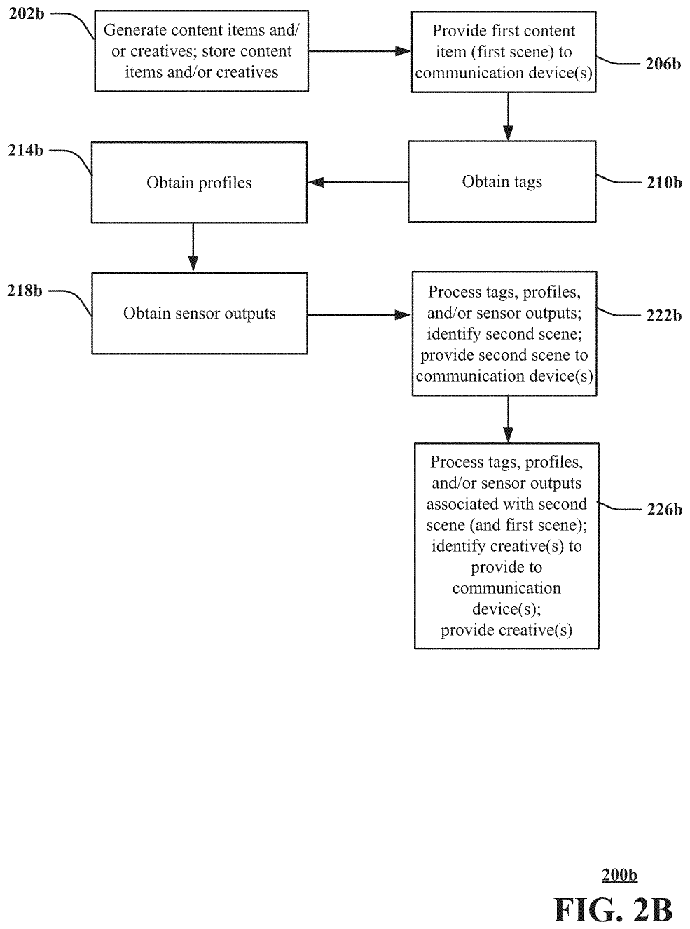

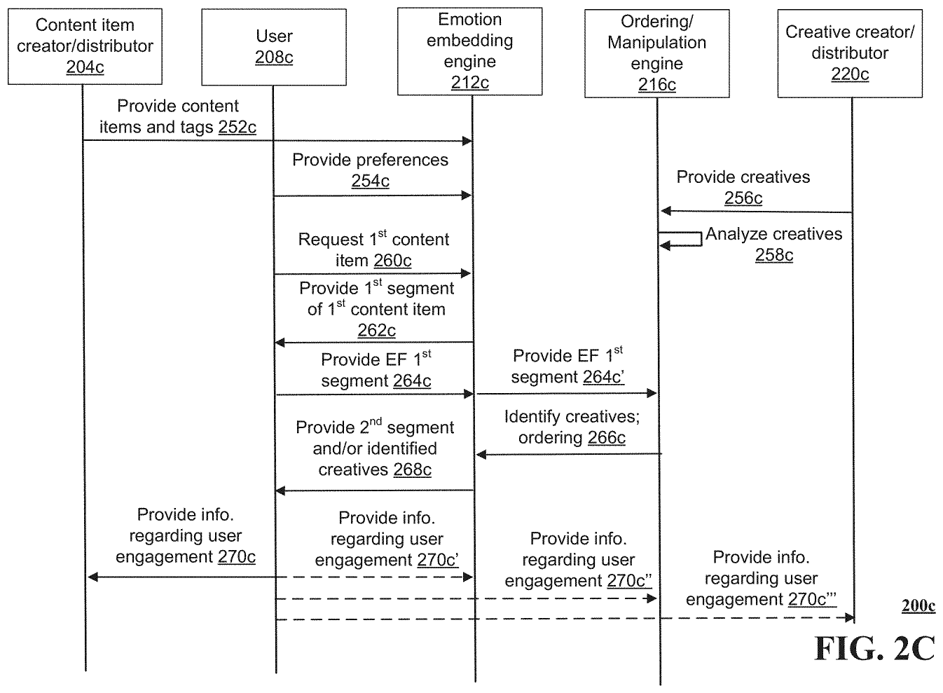

FIG. 2A is a block diagram illustrating an example, non-limiting embodiment of a system 200a functioning within, or operatively overlaid upon, the system 100 of FIG. 1 in accordance with various aspects described herein. While the various entities shown in FIG. 2A are described separately below, one skilled in the art will appreciate, based on a review of this disclosure, that in some embodiments two or more of the entities may be co-located within a common structure (e.g., a common casing or housing). In some embodiments, one or more of entities shown in FIG. 2A may be included as part of one or more communication devices (e.g., one or more servers, routers, switches, modems, gateways, client devices, user equipment, etc.). For the sake of ease in description and illustration, operations that may be performed by the system 200a are described below in relation to FIG. 2B. Accordingly, reference may be made to FIGS. 2A-2B in the description that follows.

FIG. 2B depicts an illustrative embodiment of a method 200b in accordance with various aspects described herein. In some embodiments, blocks/operations of the method 200b may be implemented/executed in conjunction with the system 200a. More generally, aspects of the method 200b may be implemented in conjunction with one or more systems, devices and/or components, such as for example the systems, devices, and components described herein.

The system 200a may include content items and/or creatives 204a. The content items/creatives 204a may be included/stored as part of a storage device (e.g., a memory, a database, etc.). The content items/creatives 204a may be partially or wholly maintained by a content item or creative creator. The content items/creatives 204a may be partially or wholly maintained by a content item or creative distributor. As part of block 202b, the content items and/or creatives 204a may be generated/created and/or saved/stored as, e.g., data and/or metadata.

A first scene 208a associated with a first content item (where data associated with the first content item may be present/included as part of content items 204a) is shown in FIG. 2A. In the exemplary embodiment of FIG. 2A, the first scene 208a depicts two friends (e.g., a first friend 208a-1 and a second friend 208a-2) preparing to share an embrace. For purposes of this example, it may be assumed that the friends 208a-1 and 208a-2 are going to hug one another following an argument that occurred during the first scene 208a. The first scene 208a may be one of many scenes/segments associated with the first content item.

As shown in block 206b, the (data associated with the) first content item (e.g., the first scene 208a) may be provided (e.g., transmitted) to one or more communication devices (e.g., a user device). As part of block 206b, upon obtaining (e.g., receiving) the first content item, a communication device may save/store the first content item to facilitate a future presentation and/or may present the first content item.

As part of generating the first scene 208a, the content creator that created the first scene 208a may append one or more tags 212a to the data associated with the first scene 208a. For example, the tags 212a may be included/incorporated as metadata that may provide a description of the first scene 208a. In particular, the tags 212a may include a specification/description of one or more emotions/feelings/emotional states that may be desired in one or more users that is/are consuming (e.g., viewing) the first scene 208a. In this illustrative example related to the first scene 208a, the tags 212a may include emotions/feelings of anger (e.g., associated with the aforementioned argument between the friends 208a-1 and 208a-2) and love (e.g., associated with the aforementioned embrace between the friends 208a-1 and 208a-2). In some embodiments, the tags 212a may include timestamps, pointers, or other references to particular portions/segments associated with a content item or a scene.

In some embodiments, the emotions/emotional state captured by/included in the tags 212a may include tags as provided by a distributor of the first content item. The tags provided by the distributor may replace tags provided by a creator of the first content item and/or may supplement tags provided by the creator of the first content item.

In some embodiments, the emotions/emotional state captured by/included in the tags 212a may include tags as provided by users or an audience of the first content item. For example, if the particular rendering of the first scene 208a shown in FIG. 2A corresponds to a replay of the first scene 208a following an initial presentation (e.g., a live broadcast) of the first content item, the tags 212a may include feedback from users that previously consumed the initial presentation.

In some embodiments, the tags 212a may include other descriptors beyond emotional states. For example, the tags 212a may include a specification of a genre of the first content item (e.g., drama, comedy, etc.), a description of persons (e.g., actors/actresses) in the first content item, an identification of a production studio or other creator of the first content item, a transcript of dialog included in the first content item, closed-captioning information, an identification of audio (e.g., music) included in the first content item, etc.

Information or data associated with the tags 212a may be obtained as part of block 210b. Block 210b may include a creation/generation of the tags 212a in a first instance and/or may include acquiring the tags 212a from a storage device in subsequent instances. In some embodiments, the creation/generation of the tags 212a as part of block 210b may be based on performing content analysis via, e.g., one or more processors.

The system 200a may include one or more profiles 216a. The profiles 216a may include user profiles. A user profile may include an identification of activities and/or preferences associated with a given user. For example, a user profile may include a specification/identification of: social media activities engaged in by a user, product or service purchases made by the user, communication sessions engaged in by a user, media consumed by the user, a calendar/schedule of events or activities of the user, locations/places where the user is or has previously visited, etc.

The profiles 216a may include device profiles. A device profile may include a specification/identification of a type of a communication device utilized by a given user, a capability of a communication device utilized by a given user, etc.

Information or data associated with the profiles 216a may be obtained as part of block 214b. Block 214b may include a creation/generation of a profile 216a in a first instance and/or may include acquiring the profile 216a from a storage device in subsequent instances.

The system 200a may include one or more sensors 220a. The sensors 220a may include a microphone that may be used to capture audio (of users) in proximity to where the first content item or first scene 208a is rendered, a camera to capture images and/or video in proximity to where the first content item or first scene 208a is rendered, etc. In some embodiments, the sensors 220a may include biometric sensors (e.g., pulse monitoring sensors, cortisol monitoring sensors, gaze monitoring sensors, etc.). Taken individually, or in any combination, the sensors 220a may be used monitor user responses or actions during a presentation of the first content item (inclusive of a presentation of the first scene 208a).

Information or data associated with the sensors 220a may be obtained as part of block 218b. Block 218b may include acquiring outputs of the sensors 220a in a first instance and/or may include retrieving the outputs of the sensors 220a (or processed or filtered versions of the outputs of the sensors 220a) from a storage device in subsequent instances.

The system 200a may include one or more processors, as represented by a processor 224a. In block 222b, the processor 224a may process the tags 212a, the profiles 216a and outputs of the sensors 220a, as obtained in blocks 210b through 218b, in relation to a presentation of the first scene 208a. The processing of block 222b may conform to one or more algorithms, such as for example a machine learning-based algorithm, an artificial intelligence-based algorithm, etc.

As part of block 222b, the processor 224a may identify a second scene 234a that may be provided one or more identified communication devices. For example, the second scene 234a may be provided/presented following the presentation of the first scene 208a. The second scene 234a may be associated with, or included as part of, the first content item. In some instances, the second scene 234a may be associated with, or included as part of, a second content item that is different from the first content item. Data associated with the second scene 234a may be obtained from the content items/creatives 204a as part of block 222b.

In the illustrative embodiment of FIG. 2A, the second scene 234a may be associated with a football game/match (as represented by a football 234a-1, a goalpost/uprights 234a-2, and an endzone 234a-3). The second scene 234a (or, analogously, the second content item) may have been selected by the processor 224a in block 222b for a user (or set of users) based at least in part on the user's/users' emotional state(s) (captured by the outputs of the sensors 220a—see block 218b) associated with the argument of the first scene 208a, potentially in combination with the tags 212a (e.g., the aforementioned tag of “anger”—see block 210b) and/or the profiles 216a (e.g., a profile for the user indicating that the user watched a hockey game in the prior week—see block 214b). For example, and as one skilled in the art will appreciate based on a review of this disclosure, participants (e.g., opponents) in a football game will frequently engage in acts of aggression with respect to one another during the football game, such acts of aggression including blocking, tackling, etc. These acts of aggression (e.g., controlled rage) may bear an emotional resemblance to the emotions/feelings associated with the argument described above in relation to the first scene 208a (see block 206b). Similarly, and as one skilled in the art will appreciate based on a review of this disclosure, participants (e.g., teammates) in the football game will frequently engage in acts of celebration with respect to one another during the football game, such acts of celebration including high-fiving/slapping hands, hugging, etc. These acts of celebration (frequently accompanied by emotions of elation, joy, etc.) may bear an emotional resemblance to the emotions/feelings (as manifested/represented in the tags 212a and/or outputs of the sensors 220a—see blocks 210b and 218b) associated with the embrace between the friends 208a-1 and 208a-2 described above in relation to the first scene 208a.

In some embodiments, as part of block 222b the second scene 234a (or, analogously, the second content item) may be provided to one or more users or communication devices as a recommendation that the user(s) may select/accept or decline/reject. As part of block 222b, user selections and/or rejections may be provided as feedback to the profiles 216a to facilitate future recommendations.

During the presentation of the football game associated with the second scene 234a, the user's emotions or behaviors/actions/responses may be monitored by the sensors 220a. Tags/metadata associated with the football game, or the second scene 234a, may be included in the tags 212a. In block 226b, the processor 224a may assess/analyze the tags 212a and/or the outputs of the sensors 220a, potentially in conjunction with the profiles 216a, to identify one or more creatives (e.g., advertisements), such as for example a first creative 240a and a second creative 244a, that may selectively be used to populate inventory (e.g., commercial breaks) available within the football game.

Block 226b may include an acquisition of data/information associated with tags, profiles, and/or sensor outputs for the second scene 234a (similar to what is shown in blocks 210b-218b for the first scene 208a described above). Stated slightly differently, the acquisition of tags, profiles, and/or sensor outputs may be executed periodically and/or in response to an occurrence of one or more events or conditions (or a lack thereof), potentially as part of one or more background tasks of one or more algorithms.

The analysis provided by the processor 224a in block 226b may be based on the information/data acquired by the processor 224a associated with the football game itself (to identify emotions that are likely experienced by one or more users during a presentation of the football game/the second scene 234a), or may be based in part on the processing of block 222b to identify an emotional trajectory that the user(s) has/have undergone/taken in conjunction with a combination of the presentation of the first scene 208a and the second scene 234a. For example, if the analysis provided by the processor 224a in block 226b indicates that a user has felt/experienced only “negative feelings” (e.g., anger, rage, etc.) in conjunction with the presentations of the first scene 208a and the second scene 234a, the user may be in need of an emotional pick-me-up, and thus the processor 224a may identify the first creative 240a to provide to the user (where the first creative 240a corresponds to a first advertisement for a warm, soothing beverage 240a-1). Similarly, if the analysis of block 226b indicates that the user has felt/experienced only “positive feelings” (e.g., joy, happiness, etc.) in conjunction with the presentations of the first scene 208a and the second scene 234a, the user may be in need of a grounding/reality check, and thus the processor 224a may identify the second creative 244a to provide to the user (where the second creative 244a corresponds to a second advertisement for a security system for a home 244a-1 in order to thwart/discourage burglaries or invasions). Block 226b may include providing the first creative 240a or the second creative 244a, as applicable, to the communication device(s) of the user.

While the examples set forth immediately above related to altering a user's emotional trajectory in terms of the identification and provisioning of the first creative 240a or the second creative 244a, in some embodiments the user may be encouraged to continue along a same or similar emotional path/trajectory that the user was on as part of the presentations of the first scene 208a and/or the second scene 234a. A management of the user's intended emotions, as part of identifying or selecting content items, scenes, and/or creatives (see blocks 222b and 226b) to provide to a given user or set of users, may be based on one or more rules or requirements that may be specified by the user(s), contacts (e.g., friends) of the user(s), a content item or creative creator, a content item or creative distributor, or any combination thereof.

As part of block 226b, a third creative 248a may be identified and may be provided to the communication device(s) of a user. The third creative 248a (which may be an advertisement for a pie 248a-1 and ice cream 248a-2 sold by a regional grocery store in proximity to the user's residence, as potentially identified in a service billing statement or service contract) may be presented by the communication device(s) of the user after the first creative 240a or the second create 244a, as applicable, is presented by the communication device(s). Pie 248a-1 and ice cream 248a-2 may be selected if the given time of year corresponds to the Thanksgiving holiday season. At another time of year (e.g., the summer time), a presentation of the same sequence of the first scene 208a, the second scene 234a, and one of the first creative 240a or the second creative 244a may lead to an identification/selection and provisioning of a different, third creative (e.g., an advertisement for summer seasonal gear such as sunscreen and aloe-based lotions available at the regional grocery store) as part of block 226b.

Thus, as described above, aspects of the method 200b may be used to guide a user's emotions via a presentation of content items (or scenes associated therewith) and/or creatives. Aspects of adjacency or temporal sequencing as between content items (or scenes) and creatives may facilitate achieving/obtaining an intended/targeted emotional state in a user, which may prime the user to be more engaged in, or receptive to, the content items and the creatives. This, in turn, may enhance the ability of creators or distributors of a content item and/or a creative to efficiently target particular/identifiable segments/populations of users included within a larger universe of users. Stated slightly differently, aspects of the disclosure may be used to allocate scarce resources (e.g., budgets) to their most efficient uses.

As described herein, user behaviors/responses to content items and creatives may be included in feedback that may influence future/additional emotional state targeting activities. As technology of this disclosure is used/implemented, additional insight may be gained, such that the emotional state targeting that is obtained may tend to become more accurate over time. Stated slightly differently, any errors that may exist in terms of a targeting of emotional states of users may tend to converge towards zero the more that the technology is utilized.

Referring now to FIG. 2C, an illustrative embodiment of a system 200c in accordance with aspects of this disclosure is shown. In some embodiments, the system 200c may be implemented in conjunction with one or more aspects/entities of the system 100 and/or the system 200a of FIGS. 1 and 2A. In some embodiments, aspects of the system 200c (e.g., entities of the system 200c as described below) may be implemented in conjunction with, or facilitated by, one or more communication devices.

The system 200c may include one or more entities, such as for example a content item creator or distributor 204c, a user 208c, an emotion embedding engine 212c, an ordering/manipulation engine 216c, and a creative creator or distributor 220c. The entities 204c-220c are illustrative; other entities may be included in some embodiments.

The system 200c may be configured to perform one or more operations or steps as described in further detail below. While the steps are described with respect to FIG. 2C, in some embodiments one or more of the steps (or one or more portions thereof) may be implemented in conjunction with one or more operations/blocks of the method 200b of FIG. 2B.

In step 252c, the content item creator/distributor 204c may provide one or more content items to the emotion embedding engine 212c. As part of step 252c, the content item creator/distributor 204c may provide tags (see, e.g., tags 212a in FIG. 2A) in association with one or more of the content items. As part of step 252c, the emotion embedding engine 212c may save/store the content items and/or the tags.

In step 254c, the user 208c may provide preferences to the emotion embedding engine 212c. The preferences of step 254c may include an identified emotion/emotional state (or set/range of emotions/emotional states) that the user 208c prefers to have (or, analogously, not have). The preferences of step 254c may include a specification of an emotional trajectory that the user 208c likes or dislikes. To demonstrate, the preferences of step 254c may stipulate/indicate that the user 208c is okay with feeling both happy and sad at different points in time, but would prefer to avoid being made to feel sad immediately after feeling happy.

In step 256c, the creative creator/distributor 220c may provide one or more creatives to, e.g., the ordering/manipulation engine 216c. As part of step 256c, the ordering/manipulation engine 216c may save/store the creatives.

In step 258c, the ordering/manipulation engine 216c may analyze parameters of a given creative of step 256c, such as for example textual data, images, music, etc., to identify emotional themes associated with the creative. As part of step 258c, the ordering/manipulation engine 216c may store the identified emotional themes as metadata in conjunction with the given creative. The process of analyzing the parameters and storing the metadata may be repeated for each of the creatives of step 256c as part of step 258c.

In step 260c, the user 208c may request a first content item. For example, the request may be based on a selection of a search result (where the search result was included in a set of search results in response to a search query), a selection from a user interface (e.g., a menu, an electronic programming guide [EPG], an interactive programming guide [IPG], etc.), etc. As part of step 260c, the request may be provided to the emotion embedding engine 212c.

In step 262c, the emotion embedding engine 212c may provide (at least) a first segment of the first content item corresponding to the request of step 260c to the user 208c. For example, in relation to a streaming audio application or a streaming video application, providing segments/portions of a content item (where the segments/portions are less than a whole of the content item) may facilitate immediate presentation to the user 208c and may provide benefits in terms of preserving network resources (e.g., transmission bandwidth, resource blocks, frequency channels, time slots, etc.).

In step 264c, the user 208c may provide emotional feedback (EF) regarding the first segment. For example, the EF may be based on responses to queries/surveys posed by the system 200c to the user 208c regarding the user's feelings regarding the first segment. In some embodiments, the EF may be inferred based on outputs from one or more sensors (see, e.g., sensors 220a in FIG. 2A), potentially in accordance with one or more profiles (see, e.g., profiles 216a in FIG. 2A). As part of step 264, the EF may be obtained by the emotion embedding engine 212c.

In step 264c′, the EF in respect of the first segment may be provided to the ordering/manipulation engine 216c. While the EF is shown in step 264c′ of FIG. 2C as being provided to the ordering/manipulation engine 216c from the emotion embedding engine 212c, in some embodiments the ordering/manipulation engine 216c may obtain the EF directly from the user 208c.

In step 266c, the ordering/manipulation engine 216c may identify/select a subset of creatives (from the creatives of step 256c). The identification/selection may be based at least in part on the EF obtained by the ordering/manipulation engine 216c as part of step 264c′. For example, the emotions of the user 208c as represented in the EF may at least partially influence whether a given creative is selected as part of step 266c, and if so, where in an ordering of the subset of creatives it appears. The identification/selection of step 266c (as well as any ordering of the subset of creatives in step 266c) may be based on a comparison of the EF obtained as part of step 264c′ relative to the emotional themes identified in the metadata described above in relation to step 258c. As part of step 266c, a selection and/or ordering of the subset of creatives may be based in part on one or more pricing or bidding models. The subset of the creatives, and any specification/indication regarding an ordering thereof, may be provided to the emotion embedding engine 212c as part of step 266c.

In step 268c, the emotion embedding engine 212c may identify/select a second segment to provide to the user 208c. The second segment may be another part/portion of the requested first content item (see step 260c). In some embodiments, the second segment of step 268c may correspond to a second content item that is different from the first content item. The second segment may be identified/selected based on an analysis of the EF of step 264c.

As part of step 268c, the emotion embedding engine 212c may provide the subset of the creatives obtained as part of step 266c to the user 208c. Any ordering that is specified as part of step 266c may be maintained as part of step 268c in order to facilitate a presentation of the subset of the creatives by/for the user 208c in the specified order. In some embodiments, the emotion embedding engine 212c may insert the subset of creatives into inventory associated with, e.g., the second segment as part of block 268c.

As part of step 270c, step 270c′, step 270c″, and/or step 270c′″, information (info.) regarding a level or extent of the user 208c's engagement with, e.g., the first segment, the second segment, and/or the creatives of step 268c may be obtained by the content item creator/distributor 204c, the emotion embedding engine 212c, the ordering/manipulation engine 212c, the creative creator/distributor 220c, or any combination thereof. For example, the information of steps 270c, 270c′, 270c″, or 270′″ may identify whether the user 208c browsed to a website associated with a particular creative, whether the user completed a purchase transaction for a purchase of a product or service associated with a particular creative, etc.

The information may be analyzed/processed by the content item creator/distributor 204c as part of step 270c to identify future opportunities in respect of content items that may generate increased revenue or profits for the content item creator/distributor 204c. For example, the information may influence a plot/story line of a content item, whether to include or exclude particular/identified characters in certain scenes, etc.

The information may be analyzed/processed by the emotion embedding engine 212c as part of step 270c′ to select additional segments or content items as recommendations for the user 208c.

The information may be analyzed/processed by the ordering/manipulation engine 216c as part of step 270c″ to select alternative/different subsets of creatives and/or different orderings of creatives in connection with future inventory.

The information may be analyzed/processed by the creative creator/distributor 220c as part of step 270c′″ to identify future opportunities in respect of creatives that may generate increased revenue or profits for the creative creator/distributor 220c. For example, the information may influence a bid amount that the creative creator/distributor 220c is willing to provide in relation to such future opportunities.

While for purposes of simplicity of explanation, the respective processes are shown and described as a series of blocks or steps in FIGS. 2B-2C, it is to be understood and appreciated that the claimed subject matter is not limited by the order of the blocks/steps, as some blocks/steps may occur in different orders and/or concurrently with other blocks/steps from what is depicted and described herein. Moreover, not all illustrated blocks/steps may be required to implement the methods described herein.

Aspects of this disclosure may facilitate an extraction of an emotional impact from (a presentation of) one or more content items and one or more creatives (e.g., one or more advertisements). Based on the extracted emotional impact, decisions/determinations may be made by content item creators/distributors and creative creators/distributors. For example, creators/distributors of content items may generate plot/story lines/sequences to target a particular/identified emotional state (or a sequence/trajectory of emotional states) in a user or audience. The emotional state(s) may serve as an input to a decision-making process of an advertiser in terms of a price (e.g., a bid amount) that the advertiser is willing to pay for inventory associated with the content item. Still further, as data is generated regarding the impact/results generated from given advertisements populating given inventory, that data may be analyzed by content item creators/distributors to target/refine future plot lines/sequences in connection with additional (e.g., future) content items.

In some embodiments, biometric data may serve as an input to determine or infer one or more emotional states of a user during a presentation of a content item. The emotional state(s) may serve as an input to one or more models regarding pricing for inventory associated with the content item, selections of advertisements associated with the inventory, etc. Feedback regarding a performance of the advertisements (in terms of, e.g., clicks or other selections, product or service purchases, user emotional state(s) during a presentation of the advertisements, etc.) may be obtained. Content item creators/distributors may select content items and/or particular segments/portions of a content item to provide in accordance with the feedback.

Aspects of the disclosure provide an ability to compute/determine an emotional trajectory from a series of input creatives, content items, and/or keywords. In this respect, a time-based/temporal, targeted sequencing of (user) emotional states may be generated/obtained. In some embodiments, pre-trained models (e.g., machine learning models) may be utilized to avoid ambiguity in creative planning processes.

Aspects of the disclosure provide/facilitate/enhance control (e.g., interactive control) for an advertising buyer by specifying emotional trajectories for a system to match in terms of a target sequence. Analytical feedback may be assessed to identify new placement opportunities that previously may not have been appreciated or may have gone undetected.

In some embodiments, estimates or determinations of an emotional state, or a trajectory of emotional states, of content items (e.g., programs, movies, music, documents [such as online documents], etc.) and/or creatives (e.g., advertisements) on a user (or a community/pool/group of users) may be generated. Selections of content items (or portions or segments thereof) and/or creatives may be linked to one another in accordance with the emotional state(s) to enhance the impact that content items have on creatives, and vice versa.

In accordance with aspects of this disclosure, creatives that consume/populate inventory associated with a content item may be selected to align with one or more emotional states of one or more users during a presentation of the content item. In this respect, an efficiency of programmatic advertising may be enhanced, e.g., advertising that is selected to populate inventory may have a greater tendency to resonate with/appeal to a user that receives/consumes that inventory. In some embodiments, emotional state data/parameters may augment/supplement metadata that may be incorporated as part of a content item or creative. The emotional state data may be computed/determined in real-time (or substantially in real-time), such as during a presentation of a content item, in order to enhance the accuracy/impact of a provisioning of creatives to targeted users.

Aspects of the disclosure are directed to targeting mechanisms, whereby creatives may specify examples of other creatives (e.g., other advertisements) to follow as “emotional guides”. In this respect, the other creatives may serve as a roadmap for future creatives to follow. This roadmap may be analyzed by creative creators to generate such future creatives, as well as target those creatives to users associated with particular/specified emotional states or trajectories of emotional states.

In some embodiments, content items and/or creatives may include interactive features that may aim to elicit one or more emotional states in a user. For example, a communication device associated with a user may receive/obtain a prompt to present a content item that includes violence/aggression (e.g., a boxing match) in order to prepare/prime the user for an advertisement directed to headache-relief medicine. In some embodiments, preparing a user to receive/consume a particular creative may include modifying a segment/portion of a content item, such as for example extending/lengthening a duration of a portion of a content item, shortening a duration of a portion of a content item, summarizing a portion of a content item, altering an audio parameter (e.g., a volume level, an audio fidelity parameter, etc.) associated with a portion of a content item, altering a display parameter (e.g., a display resolution, a color, a contrast, etc.) associated with a portion of a content item, etc.

In some embodiments, emotional state data may supplement precomputed/predetermined data regarding a content item and/or a creative. In some embodiments, emotional state data may be analyzed/assessed on a global level (e.g., on a level corresponding to an entire universe/pool of users), in relation to a subset of users (e.g., less than an entirety of all users), and/or on an individual user basis. One or more timelines or timeframes may serve to identify a time period over which such emotional state data is captured and/or analyzed. In some embodiments, an analysis of emotional state data may be supplemented with information/data regarding, e.g., an occurrence of one or more events or conditions (or a lack thereof), one or more user-generated inputs (e.g., a specification of one or more user preferences), a consumption of one or more content items and/or creatives, an engagement in one or more communication sessions via one or more communication devices, location histories associated with users and/or communication devices, activities performed in relation to one or more platforms (e.g., social media platforms), schedules, etc.

In accordance with aspects of this disclosure, emotional state data may serve as an input to facilitate identifying creatives (e.g., advertisements) to populate inventory of content items. In this respect, creatives that are selected for populating/consuming the inventory may closely align with (e.g., may align within a threshold amount of) one or more emotional states of a user (or set of users), while potentially avoiding negative consequences/results associated with a presentation of a creative that is misaligned with the emotional state(s) of the user(s). By closely aligning presented creatives with user emotions/emotional states, higher/greater levels of user engagement may be obtained in respect of a presentation of a content item, which can be useful in terms of enhancing positive brand association/loyalty amongst users with respect to a content provider. For example, users may seek out additional content items of a content provider as a result of having obtained a positive experience in respect of a first content item (and associated creatives) of the content provider. These additional content items may, in turn, represent additional revenue or profit-generating opportunities for the content provider.

Aspects of this disclosure may be incorporated as information, data, and/or metadata that may be transferred/transmitted between systems, devices, and/or components. A recipient of such information, data, and/or metadata may process and/or analyze the same, and may undertake one or more (methodological) actions in accordance therewith.

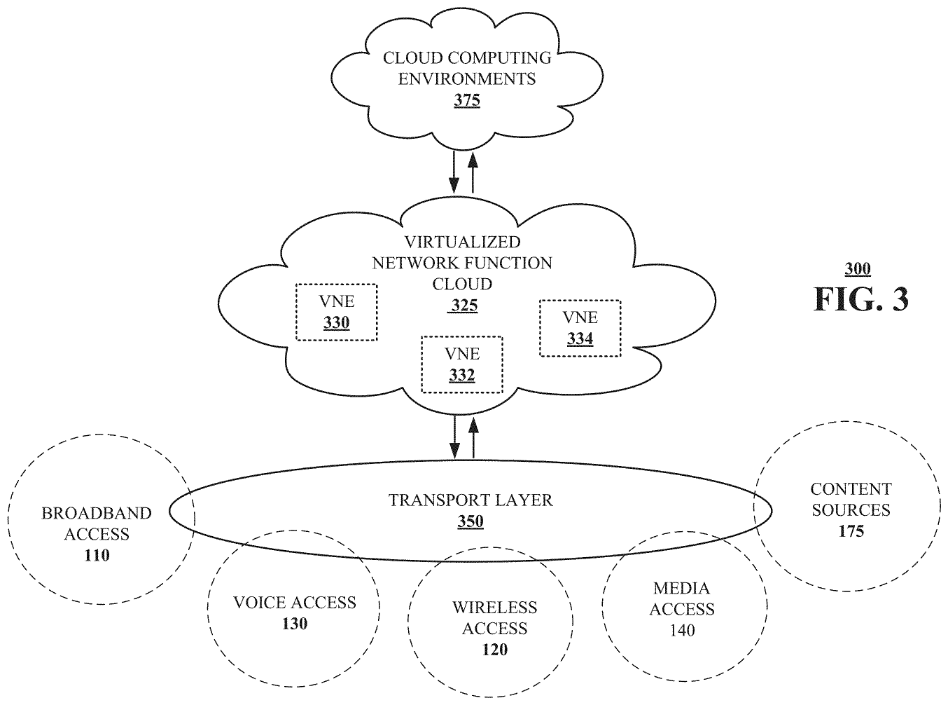

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200a and 200c, and method 200b presented in FIGS. 1 and 2A-2C. For example, virtualized communication network 300 can facilitate in whole or in part providing a first portion of a first content item to a first client device associated with a first user, obtaining first data associated with a presentation of the first portion of the first content item by the first client device, obtaining second data associated with a first profile, identifying an emotional trajectory of the first user during the presentation of the first portion of the first content item in accordance with the first data and the second data, selecting a first advertisement in accordance with the emotional trajectory of the first user, and providing the first advertisement to the first client device. Virtualized communication network 300 can facilitate in whole or in part obtaining first data associated with a first presentation of a first portion of a first video, obtaining second data from a creator of the first video, identifying an emotional trajectory of a first user during the first presentation in accordance with the first data and the second data, selecting a first creative in accordance with the emotional trajectory, and transmitting the first creative to a first communication device. Virtualized communication network 300 can facilitate in whole or in part presenting a first portion of a first content item during a first presentation, providing first data that indicates a first emotion of a first user during the first presentation, presenting, subsequent to the first presentation, a second portion of the first content item, a third portion of a second content item that is different from the first content item, or a combination thereof, during a second presentation, providing second data that indicates a second emotion of the first user during the second presentation, wherein the second emotion is different from the first emotion, and obtaining, in response to the providing of the first data and the providing of the second data, a first advertisement that is based on an emotional trajectory of the first user from the first emotion to the second emotion.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

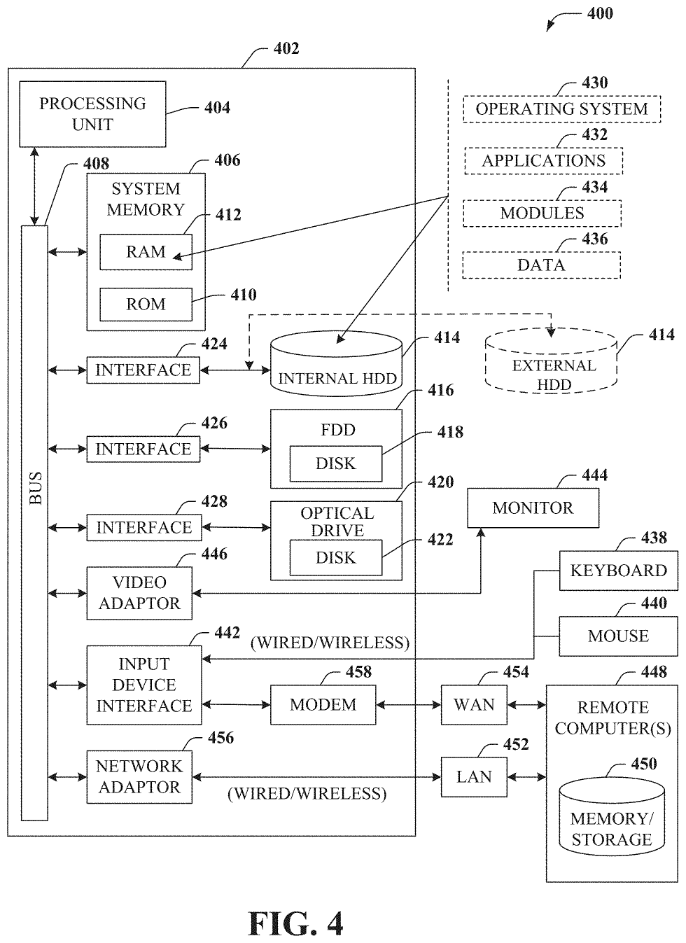

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part providing a first portion of a first content item to a first client device associated with a first user, obtaining first data associated with a presentation of the first portion of the first content item by the first client device, obtaining second data associated with a first profile, identifying an emotional trajectory of the first user during the presentation of the first portion of the first content item in accordance with the first data and the second data, selecting a first advertisement in accordance with the emotional trajectory of the first user, and providing the first advertisement to the first client device. Computing environment 400 can facilitate in whole or in part obtaining first data associated with a first presentation of a first portion of a first video, obtaining second data from a creator of the first video, identifying an emotional trajectory of a first user during the first presentation in accordance with the first data and the second data, selecting a first creative in accordance with the emotional trajectory, and transmitting the first creative to a first communication device. Computing environment 400 can facilitate in whole or in part presenting a first portion of a first content item during a first presentation, providing first data that indicates a first emotion of a first user during the first presentation, presenting, subsequent to the first presentation, a second portion of the first content item, a third portion of a second content item that is different from the first content item, or a combination thereof, during a second presentation, providing second data that indicates a second emotion of the first user during the second presentation, wherein the second emotion is different from the first emotion, and obtaining, in response to the providing of the first data and the providing of the second data, a first advertisement that is based on an emotional trajectory of the first user from the first emotion to the second emotion.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

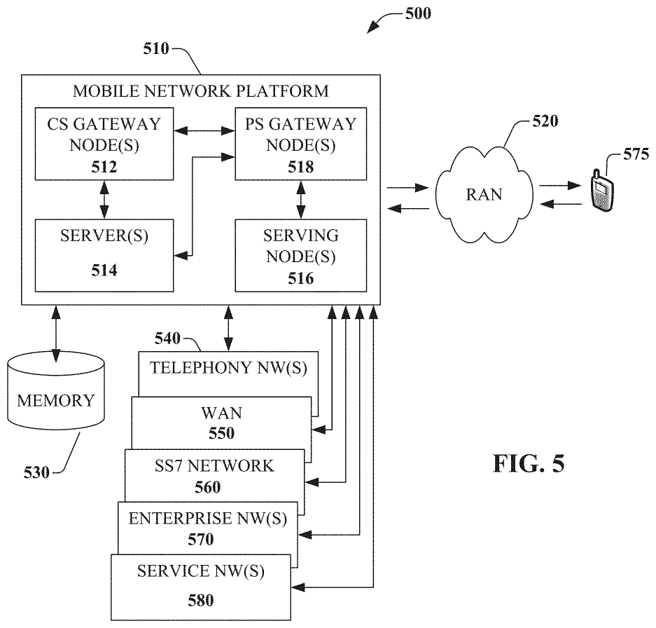

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part providing a first portion of a first content item to a first client device associated with a first user, obtaining first data associated with a presentation of the first portion of the first content item by the first client device, obtaining second data associated with a first profile, identifying an emotional trajectory of the first user during the presentation of the first portion of the first content item in accordance with the first data and the second data, selecting a first advertisement in accordance with the emotional trajectory of the first user, and providing the first advertisement to the first client device. Platform 510 can facilitate in whole or in part obtaining first data associated with a first presentation of a first portion of a first video, obtaining second data from a creator of the first video, identifying an emotional trajectory of a first user during the first presentation in accordance with the first data and the second data, selecting a first creative in accordance with the emotional trajectory, and transmitting the first creative to a first communication device. Platform 510 can facilitate in whole or in part presenting a first portion of a first content item during a first presentation, providing first data that indicates a first emotion of a first user during the first presentation, presenting, subsequent to the first presentation, a second portion of the first content item, a third portion of a second content item that is different from the first content item, or a combination thereof, during a second presentation, providing second data that indicates a second emotion of the first user during the second presentation, wherein the second emotion is different from the first emotion, and obtaining, in response to the providing of the first data and the providing of the second data, a first advertisement that is based on an emotional trajectory of the first user from the first emotion to the second emotion.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

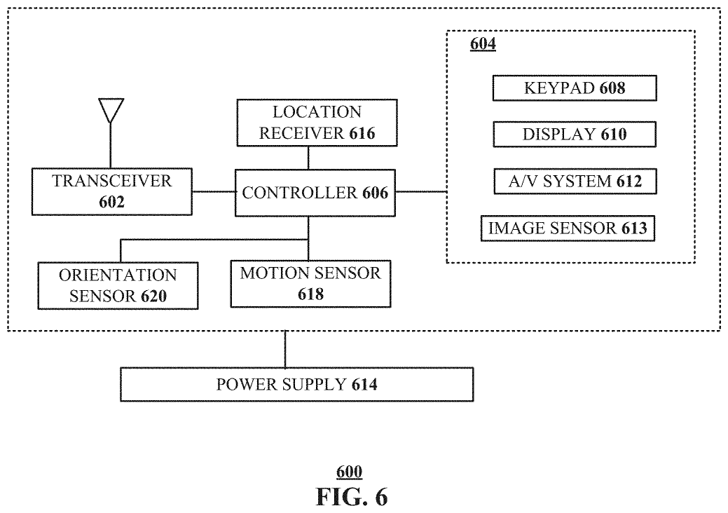

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part providing a first portion of a first content item to a first client device associated with a first user, obtaining first data associated with a presentation of the first portion of the first content item by the first client device, obtaining second data associated with a first profile, identifying an emotional trajectory of the first user during the presentation of the first portion of the first content item in accordance with the first data and the second data, selecting a first advertisement in accordance with the emotional trajectory of the first user, and providing the first advertisement to the first client device. Computing device 600 can facilitate in whole or in part obtaining first data associated with a first presentation of a first portion of a first video, obtaining second data from a creator of the first video, identifying an emotional trajectory of a first user during the first presentation in accordance with the first data and the second data, selecting a first creative in accordance with the emotional trajectory, and transmitting the first creative to a first communication device. Computing device 600 can facilitate in whole or in part presenting a first portion of a first content item during a first presentation, providing first data that indicates a first emotion of a first user during the first presentation, presenting, subsequent to the first presentation, a second portion of the first content item, a third portion of a second content item that is different from the first content item, or a combination thereof, during a second presentation, providing second data that indicates a second emotion of the first user during the second presentation, wherein the second emotion is different from the first emotion, and obtaining, in response to the providing of the first data and the providing of the second data, a first advertisement that is based on an emotional trajectory of the first user from the first emotion to the second emotion.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
providing a first portion of a first content item to a first client device associated with a first user;
obtaining first data associated with a presentation of the first portion of the first content item by the first client device;
obtaining second data associated with a first profile;
identifying an emotional trajectory of the first user during the presentation of the first portion of the first content item in accordance with the first data and the second data;
selecting a first advertisement in accordance with the emotional trajectory of the first user; and
providing the first advertisement to the first client device.

2. The device of claim 1, wherein the operations further comprise:
obtaining third data from a provider of the first content item, wherein the third data identifies an emotion that is intended during the presentation of the first portion of the first content item.

3. The device of claim 2, wherein the identifying of the emotional trajectory of the first user during the presentation of the first portion of the first content item is further in accordance with the third data.

4. The device of claim 1, wherein the presentation of the first portion of the first content item by the first client device corresponds to a replay of the first portion of the first content item, and wherein the operations further comprise:
obtaining third data from a second client device associated with a second user, wherein the third data identifies an emotion of the second user during a presentation of the first portion of the first content item by the second client device.

5. The device of claim 4, wherein the identifying of the emotional trajectory of the first user during the presentation of the first portion of the first content item is further in accordance with the third data.

6. The device of claim 5, wherein the second user is a contact of the first user on a social media platform.

7. The device of claim 1, wherein the obtaining of the first data comprises obtaining the first data from a microphone, a camera, a biometric sensor, or any combination thereof.

8. The device of claim 1, wherein the first profile comprises a first user profile associated with the first user, a first device profile associated with the first client device, or a combination thereof.

9. The device of claim 1, wherein the operations further comprise:
selecting a second portion in accordance with the emotional trajectory of the first user, wherein the second portion is part of the first content item or is part of a second content item that is different from the first content item; and
providing the second portion to the first client device.

10. The device of claim 1, wherein the operations further comprise:
selecting a second advertisement in accordance with the emotional trajectory of the first user; and
providing the second advertisement to the first client device.

11. The device of claim 10, wherein the operations further comprise:
identifying an order for the first client device to present the first advertisement and the second advertisement in accordance with the emotional trajectory of the first user; and
providing an indication of the order to the first client device.

12. The device of claim 1, wherein the operations further comprise:
obtaining third data that identifies a level of engagement of the first user with respect to the first advertisement.

13. The device of claim 12, wherein the operations further comprise:
generating a second advertisement in accordance with the third data; and
providing the second advertisement to the first client device to cause the first client device to present the second advertisement.

14. The device of claim 12, wherein the operations further comprise:
generating a second portion of the first content item in accordance with the third data; and
providing the second portion of the first content item to the first client device to cause the first client device to present the second portion, store the second portion, or a combination thereof.

15. A machine-readable medium, comprising executable instructions that, when executed by a processing system including a processor, facilitate performance of operations, the operations comprising:
obtaining first data associated with a first presentation of a first portion of a first video;
obtaining second data, wherein the second data is obtained: from a creator of the first video, by performing an analysis on the first portion of the first video, or a combination thereof;
identifying an emotional trajectory of a first user during the first presentation in accordance with the first data and the second data;
selecting a first creative in accordance with the emotional trajectory; and
transmitting the first creative to a first communication device.

16. The machine-readable medium of claim 15, wherein the operations further comprise:
obtaining third data from a distributor of the first video,
wherein the identifying of the emotional trajectory of the first user is further in accordance with the third data.

17. The machine-readable medium of claim 15, wherein the operations further comprise:
selecting a second portion of the first video in accordance with the emotional trajectory;
transmitting the second portion of the first video to the first communication device;
selecting a second creative in accordance with the emotional trajectory and the selecting of the first creative; and
transmitting the second creative to the first communication device.

18. The machine-readable medium of claim 17, wherein the first creative comprises a first advertisement and the second creative comprises a second advertisement, and wherein the operations further comprise:
transmitting, to the first communication device, a first indication of first inventory available in the first video to be populated with the first advertisement; and
transmitting, to the first communication device, a second indication of second inventory available in the first video to be populated with the second advertisement.

19. A method, comprising:
presenting, by a processing system including a processor, a first portion of a first content item during a first presentation;
providing, by the processing system, first data that indicates a first emotion of a first user during the first presentation;
presenting, by the processing system and subsequent to the first presentation, a second portion of the first content item, a third portion of a second content item that is different from the first content item, or a combination thereof, during a second presentation;
providing, by the processing system, second data that indicates a second emotion of the first user during the second presentation, wherein the second emotion is different from the first emotion; and
obtaining, by the processing system and in response to the providing of the first data and the providing of the second data, a first advertisement that is based on an emotional trajectory of the first user from the first emotion to the second emotion.

20. The method of claim 19, wherein the first content item comprises a video, an image, music, a document, or any combination thereof, wherein the processing system is included in a first client device, wherein the obtaining of the first advertisement is further based on a location of the first client device, a demographic characteristic included in a user profile associated with the first user, a device profile associated with the first client device, and a bid amount associated with the first advertisement, the method further comprising:
obtaining, by the processing system, a second advertisement that is based on the emotional trajectory of the first user and an identification of the first advertisement;
presenting, by the processing system, the first advertisement; and
presenting, by the processing system, the second advertisement subsequent to the presenting of the first advertisement.
